(19) United States
(12) Patent Application Publication
(10) Pub. No.: US 2003/0164936 A1
(43) Pub. Date: Sep. 4, 2003

(54) Optical system for distance and angle measurement

(76) Inventors: Wilfried Mehr, Lindau (DE); Holger Schanz, Lindau (DE)

Correspondence Address: FASSE PATENT ATTORNEYS, P.A., P.O. BOX 726, HAMPDEN, ME, 04444-0726, US

(21) Appl. No.: 10/296,143

(22) PCT Filed: May 9, 2001
(86) PCT No.: PCT/EP01/05234

(30) Foreign Application Priority Data
May 22, 2000 (DE) 100 25 258.3

(51) Int. Cl. G01C 3/08; B62D 1/24; B60T 7/16

(52) U.S. Cl. 356/4.01; 180/169

(57) ABSTRACT

It shall be made possible, in a simple manner and with low costs, to achieve a determination of the distance between a reference object and at least one target object located in the surveillance area and/or the speed of at least one target object located in the surveillance area, with high accuracy.

For this purpose, in the optical system, the surveillance area is divided into several target sectors that respectively encompass a certain angular range in horizontal direction and vertical direction. The measuring unit acquiring the measured values comprises a receiver unit with a number of parallel-connected receiver elements corresponding with the number of the target sectors, whereby each receiver element detects the reflected signal from one of the target sectors as received signal. A control unit connected after the measuring unit comprises a number of evaluating stages corresponding to the number of the receiver elements, whereby each evaluating stage evaluates the received signal of a receiver element stemming from a target sector.

Optical system to be implemented in driver assistance systems for motor vehicles.

Optical systems are utilized for determining the distance of a reference object to moving or stationary objects (target objects) and/or for determining the speed or velocity of moving or stationary objects (target objects) for various different observation or surveillance areas (distance ranges). These optical systems especially find applications in surveillance areas with a small distance between the reference object and the target objects (“near or close range”, for example, depending on the application, a distance up to 20 m or 250 m), for example for detecting the traffic space surrounding a motor vehicle, that is to say for determining the distance (the spacing) of a motor vehicle as a reference object to preceding, following, or oncoming vehicles or other reflecting objects, and/or the speed of preceding, following or oncoming vehicles or other reflecting objects. The optical transmitted signal (which is especially emitted in the infrared (IR) spectral range or in the visible spectral range) emitted in the measuring phases from a transmitter unit of a measuring unit is detected by the receiver unit of the measuring unit after the reflection from the target objects located in the surveillance area, and this is evaluated as a received signal (reflected signal) by a control unit (evaluating unit) after the signal processing (further processing) with respect to the transit time; from this, especially the desired distance information and/or speed information can be obtained. In pulsed optical systems, the optical transmitted signal is cyclically interrupted in the measuring phases, that is to say, optical transmitted pulses with a certain pulse duration are emitted as an optical transmitted signal in the measuring phases; in the pulse pauses between two optical transmitted pulses, the reflected signals of the preceding optical transmitted pulses are detected as received signals. In continuous optical systems, the optical transmitted signal is continuously emitted (“continuous wave” cw), whereby the transmitting frequency of the optical transmitted signal is varied, that is to say, comprises a certain modulation course or progression by means of frequency modulation (FM); simultaneously the received signal is detected.

It is the underlying object of the invention to propose an optical system with which it becomes possible to determine the distance between a reference object and target objects and/or the speed or velocity of target objects in a simple manner and with low costs, and which can be used flexibly for a plurality of applications.

This object is achieved according to the invention by the features in the characterizing portion of the patent claim 1. Advantageous further developments of the optical system are the subject matter of the further patent claims.

In the proposed optical system, a transit time measurement of optical signals is carried out in parallel in several (receiver) channels, whereby the reflected signal arising out of a certain surveillance area is respectively measured and further processed simultaneously (in parallel) by a receiver unit with several receiver elements; that is to say, target objects from various different angular ranges are ascertained and the distances to these target objects and/or the speeds of these target objects are determined simultaneously in several receiver channels with a large opening or aperture angle (in the horizontal plane and in the vertical plane).

For this purpose, the optical transmitted signal is emitted in a large angular range in horizontal and vertical direction, that is to say a large opening or aperture field in the close range is “illuminated”, with at least one transmitter element of a transmitter unit of a measuring unit, which operates in the visible or infrared spectral range, (for example a transmitter diode or especially a semiconductor laser). The detected angular range (the aperture field) is examined in a locally resolving manner with a receiver unit of the measuring unit, which receiver unit comprises several receiver elements arranged in the manner of an array; for example, the receiver elements operating in the visible spectral range or the infrared spectral range are embodied as receiver diodes or as photo-receivers or as photo-transistors, for example 16 PIN-diodes arranged in the manner of an array are provided as receiver elements. The optical received signal is detected simultaneously with all of the receiver elements of the receiver unit that are allocated to various different target sectors in the aperture field, that is to say the reflected signals from all of the target sectors of the aperture field are simultaneously (in parallel) detected in various different receiver channels, whereby a target object is allocated to each receiver channel. After a signal amplification and signal conversion of each receiver channel (1 bit conversion) carried out in the receiver unit, the amplified and digitally converted received signal is delivered to the control unit and is there first separately further processed. In the control unit, a separate evaluating stage is allocated to each receiver channel, to which separate evaluating stage the amplified and digitized measured values of the measuring unit from each measuring phase, that is to say the digital received signals of all receiver channels, are simultaneously delivered, that is to say one receiver channel and therewith one target sector is allocated to each evaluating stage. In successive measuring phases of a measuring process, the reflected signals from the distance ranges or areas are detected, whereby in each measuring phase the reflected signals from a particular distance range are detected, that is to say in each measuring phase, the target objects located in a particular distance range of the allocated target sector are determined; the distance resolution is thus achieved in connection with the distance range. The digital received signals arising from the allocated target sector from the measuring phases of a measuring process are stored in each evaluating stage. Simultaneously, the received signals from several successive measuring processes are stored, and from this, the time development or evolution of the target objects in each distance range is determined (for example the speed of the target objects by comparison of the target sectors); the time resolution is thus achieved in connection with the comparison of successive measuring processes. The storing of the digital received signals of the measuring phases of one measuring process and from successive measuring processes may, for example, be carried out in a memory unit embodied as a shift register array. The digital received signals of successive measuring processes stored in the memory unit are evaluated, for example by comparison with a digital threshold value by a threshold value stage of the evaluating stage, so that hereby evaluated received signals are generated; the presence of target objects in the allocated target sector and their distance is determined with this evaluated received signal by each evaluating stage, whereby the speed of the target objects can be determined by differentiation of the digital received signals from successive measuring processes of the distance, that is to say by the time variation of the position (the distance) of the individual target objects. These evaluated received signals are delivered as an output signal of each evaluating stage to a (common) testing unit. With the output signals of all evaluating stages (that is to say with the evaluated received signals of all receiver channels), a matrix of the target objects is formed (object matrix) in the testing unit. By a comparison of the data of neighboring or adjacent evaluating stages (gradient formation), that is to say by an evaluation of neighboring or adjacent target objects of the object matrix (especially with respect to speed and distance), an additional plausibility testing of the object matrix or of the information of the receiver channels can be carried out in the testing unit.

The optical system can be flexibly adapted to the respective application, especially by prescribing or prespecifying the number and the repeat frequency of the measuring phases, the number and the arrangement of the receiver elements, the number of the measuring phases per measuring process and therewith of the distance ranges, and the evaluation of the received signals in the individual receiver channels.

Preferably, a pulse process is utilized for the distance determination between the reference object and the target objects, that is to say the determination of the transit time of optical pulses serves as the basis for the distance measurement between the reference object and the target objects.

Advantageously, the optical system possesses:

a simple construction, because no expensive components are needed (especially, for most applications, due to the simple process sequence, no complex program structure and thus also no microprocessor is needed), because a small manner of construction of the sensor can be realized due to the small number of components, and because preferably a (safely operatable) simple semiconductor layer (laser class I) can be used as the transmitter element.

a large field of application, that is to say it is flexibly useable for many different applications in the near or close range, whereby the specifications of the optical sensors and their components (measuring unit, that is to say transmitter unit and receiver unit as well as control unit) can be adapted in a simple manner to the respective application (that is to say no customer specific adaptation is generally necessary).

In the following, an example embodiment of an optical system, implemented in a motor vehicle, for determining the distance by means of optical IR-pulses is explained in further detail in connection with the drawing.

In this context, there is shown in:

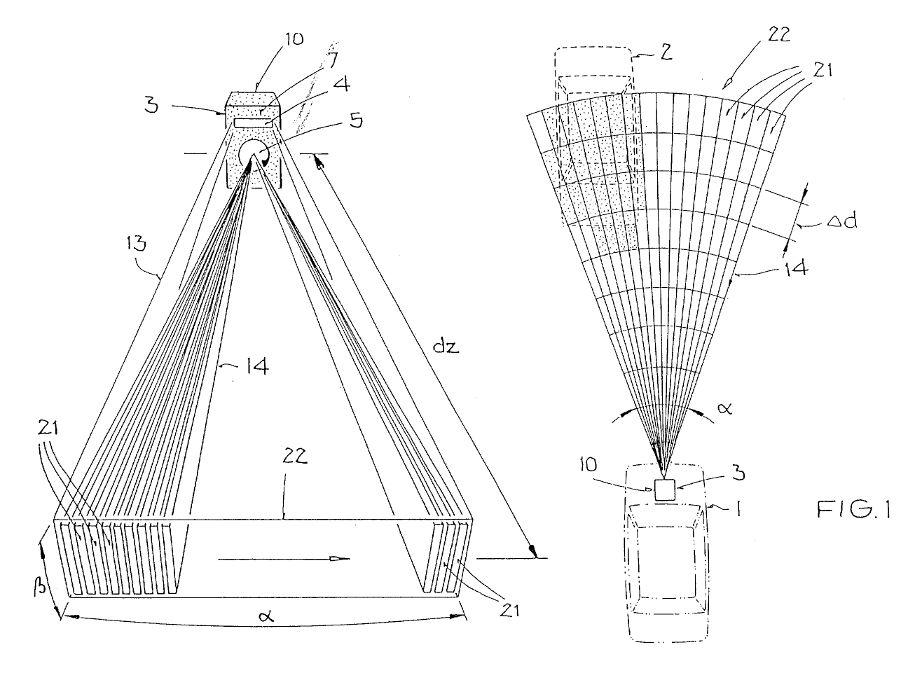

FIG. 1 a schematic illustration of the principle basically underlying the distance determination,

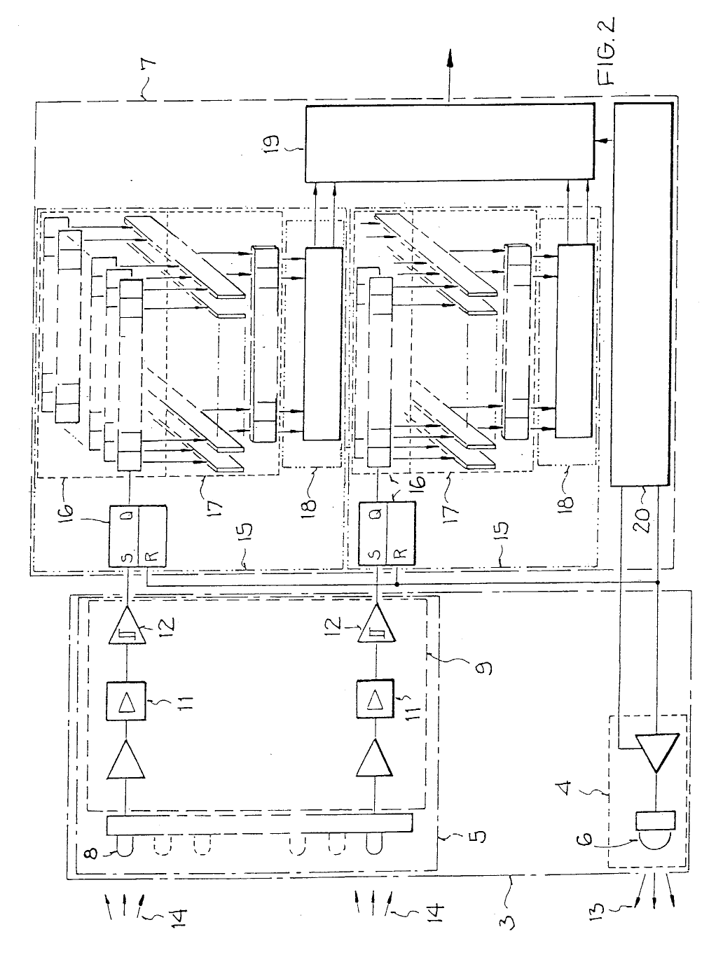

FIG. 2 a schematic block circuit diagram of the optical system.

In the near or close range of a motor vehicle, the distance and/or the speed of target objects located in the surveillance area, that is to say the spacing distance between the own motor vehicle and preceding, oncoming, or following vehicles, persons and other reflecting objects and/or the speed of preceding, oncoming or following vehicles, persons and other reflecting objects, can find use as a basis for driver assistance systems. The distance and/or speed must be determined unambiguously and with high resolution, for example, the desired distance unambiguity range amounts to 10 m, the desired distance resolution 0.5 m, and the desired speed resolution 1 m/s.

According to the FIG. 1, the optical system 10 is implemented of measuring unit 3 (transmitter unit 4 and receiver unit 5) and control unit 7 (evaluating unit) with the dimensions of, for example 65 mm×30 mm×25 mm, at a prescribed position, which depends on the application, in or on the motor vehicle 1.

In several measuring phases of a measuring process, a transmitted signal 13 is emitted as an optical signal in the infrared (IR) spectral range with the wavelength of, for example, 850 nm, from the transmitter unit 4 of the measuring unit 3; the reflected signal 14 that is obtained by reflection from the target objects 2 (for example the preceding vehicles or obstacles) located in the aperture field 22, that is to say in the distance range and angular range (horizontal aperture angle α, for example α=50°; vertical aperture angle β, for example β=12°) detected by the transmitted signal 13, is detected as an analog received signal by the receiver unit 5 of the measuring unit 3. The received signal is evaluated with respect to the transit time by a control unit 7 (which simultaneously functions as evaluating unit), and the distance information is obtained from the reflected signals from various different measuring phases, and the speed information is obtained from the reflected signals of successive measuring processes, that is to say the distance dz between the motor vehicle as reference object 1 and reflecting objects as target object 2 and/or the speed of the reflecting objects as target object 2. The aperture field 22 or the detected angular range (aperture angle α, β) is divided into several target sectors 21, whereby each target sector 21 comprises several distance ranges Δd, in which target objects 2 are respectively detected, and in connection with the information of which, an object matrix of the target objects 2 is established (for example the aperture field 22 or the detected angular range is divided into 16 target sectors 21 with respectively 16 distance ranges Δd, so that for a horizontal aperture angle α of, for example, 50°, and a vertical aperture angle β of, for example, 12°, each target sector 21 of the aperture field 22 encompasses approximately 3.1° by 0.75°. In this context, in a measuring phase of the measuring process, a certain distance range Δd within the allocated target sector 21 is selected, whereby all distance ranges Δd of the target sector 21 are successively interrogated or polled in the measuring phases of a measuring process.

The measuring unit 3 and the control unit 7 of the optical system 10 with their respective components are illustrated in the FIG. 2.

The transmitter unit 4 of the measuring unit 3 comprises a transmitter element 6, for example embodied as a pulsed IR semiconductor laser, whereby the IR semiconductor laser emits a pulse-form transmitted signal 13 with a power of, for example, 10 W and a wavelength of, for example, 850 nm (in comparison, the average optical power of the IR semiconductor laser amounts to only approximately 1 mW, so that it is allocated to the harmless laser class I).

For the parallel detection of the reflected signal 14 from various different target sectors 21 of the aperture field 22, the receiver unit 5 of the measuring unit 3 comprises a receiver array with several receiver elements 8, of which respectively one receiver element 8 is allocated to a target sector 21 defined by the aperture angles α and β and thus in effect forms a receiver channel for a certain target sector 21; for example a receiver array with 16 receiver elements 8 is provided. The receiver elements 8 are, for example, embodied as IR receiver diodes, which are sensitive for the wavelength of the transmitted signal 13 of 850 nm, for example. The received signal is amplified in an analog manner and converted into a digital signal by the amplifier unit 9, whereby an amplifier element 11 and converter element 12 in the manner of a 1 bit A/D converter are provided in the amplifier unit 9 for each receiver element 8, wherein the amplifier element 11 and the converter element 12 amplify the received signal allocated to a target sector 21 and convert it into a digital received signal.

The results of the reflection measurements (the reflected signals 14 that have been processed into the digital received signal) are evaluated by means of the control unit 7 (evaluating unit) connected after or downstream of the measuring unit 3; from the results of which, distances and/or speeds can be derived and the results thereof can be corrected by means of plausibility considerations. The digital received signal prepared and provided by the receiver unit 5 is supplied to evaluating stages 15, whereby an evaluating stage 15 is provided for each receiver element 8 of the receiver array (and therewith for each receiver channel); thus, with 16 receiver elements 8 (and therewith 16 receiver channels), there are provided 16 evaluating stages 15, through which the object information of the various receiver channels is processed in parallel.

For this purpose, each evaluating stage 15 comprises a memory stage 16 embodied as a fast clocked shift register array (clock frequency for example 100 MHz to 200 MHz) for buffering the measurement results from several successive measuring phases of a measuring process (distance information) and from several successive measuring processes (time information) (for example a 16×16 shift register array is provided, that is to say per measuring process, 16 distance ranges Δd of the allocated target sector 21 can be detected and stored, and also the information from 16 successive measuring processes can be stored), a threshold value stage 17 for evaluating the buffered measurement results with respect to the occurrence frequency or probability of target objects 2 arising in the corresponding receiver channel in the individual measuring processes (for example, a target object 2 is evaluated as being present if it is present in more than one half of the stored successive measuring processes in the respective receiver channel, for example in more than 8 of the 16 stored successive measuring processes with a 16×16 shift register array), and a calculating or computing stage 18 for determining the distance information in connection with the distance ranges Δd and/or the speed information in connection with the variation in the successive measuring processes on the basis of the evaluated received signals. The output signals (evaluated received signals) provided by each evaluating stage 15 are delivered to a test unit 19, which subjects the output signals of the evaluating stages 15 to a plausibility consideration, for example by comparison of the output signals of neighboring or adjacent evaluating stages 15 (and therewith receiver channels), for example with respect to the speed or the size of the determined target objects 2. Furthermore, there is provided a control logic 20, by which a correlation is carried out between (the transmitter element 6 of) the transmitter unit 4 and the testing unit 19, and therewith between the measuring process or the measuring phase of the measuring process and the output signals of the evaluating stages 15 that are to be tested.

Cyclical measurements are carried out during the time duration in which the optical system 20 is activated in the motor vehicle 1. A certain number of measuring phases is allocated to a measuring process, whereby various different distance ranges Δd are generated; for example a measuring process (time duration for example 1.6 ms) is divided into 16 measuring phases (time duration for example respectively 40 μs), so that 16 distance ranges Δd are generated, of which the measurement results are stored in the memory stages 16 of the control unit 7. Furthermore, the measuring results of successive measuring processes are stored in the memory stages 16 of the control unit 7, for example of 16 successive measuring processes.

For example a quartz oscillator with a clock frequency f of 100 MHz (clocking unit tq=1/f=10 ns) is utilized as a time reference for the measurements. The detection time of the optical system 10 for distance measurements (this corresponds to the time duration until a memory stage 16 of the shift register array of the evaluating stage 15 is filled with data and thus an evaluation can be carried out) amounts to, for example, 1.6 ms. The speed information for the target objects 2, which is determined from successive distance measurements, may, for example, be detected in a range between 1 m/s and 468 m/s. The distance resolution amounts to 0.75 m, for example.

Depending on the arrangement of the optical system 10 in the motor vehicle 1, and the evaluation or processing of the measurement results, various different applications as a driver assistance system are conceivable:

Early warning of an impact (“precrash warning”), for example in connection with a frontal impact, side impact, or rear impact, whereby the optical system 10, for an impact or crash warning, is arranged in the area of the rear view mirror with respect to a frontal impact, is arranged in the area of the door column with respect to a side impact, and is arranged in the rear window with respect to a rear impact. The approach speed of the target objects 2 is measured by the optical system 10, and from the distance of the target objects 2, the speed of the target objects 2, and the angle of the vehicle 1 relative to the target objects 2, through the use of a plausibility algorithm, the vehicle 1 or the driver is informed, whether a “crash” is imminent. Additionally, the expected impact speed can be indicated to the drive of the vehicle 1.

Detection in the blind spot angle (“blind spot detection”). The optical system 10 arranged in the side area of the vehicle 1, for example in the side view mirror, recognizes target objects 2 that are located in the blind angle range or blind spot and are not visible to the driver of the vehicle 1, and notifies the driver of the vehicle 1 thereof.

Lateral lane guidance (“lateral control support” or “overtaking/passing and lane merging”). The optical system 10 arranged in the side area of the vehicle 1, for example in the side view mirror, detects obstacles as target objects 2 located in the side area or rearward area of the vehicle 1 and evaluates them, for example with respect to their speed; upon an intended veering out from the driving lane or a lane change, the driver of the vehicle 1 is notified of relevant target objects 2 (obstacles), and the driver is warned of fast (and thus dangerous) obstacles.

Support of a stop and go function (“stop and go assistance”). The optical system 10 arranged in the frontal area of the vehicle 1, for example in the headlight, bumper, or radiator grill, conveys the object matrix in the intended or expected driving path of the vehicle 1 (the “driving hose” or sluice) to a calculating or computing unit connected subsequently or downstream thereof; from the offset to the center line (the deviation) and the distance, the free space in front of the vehicle can be measured. A driving start (“go”) initiated by the driver thereby receives an additional safety or security.

Support of emergency braking (“emergency braking”). An emergency braking initiated by the driver is supported by the optical system 10 arranged in the frontal area of the vehicle 1, for example in the headlight, bumper, or radiator grill, corresponding to an intensified or accentuated stopping according to the stop and go function.

Parking space measurement. A distance profile is determined by the optical system 10 arranged in the side area of the vehicle 1, for example in the area of the door column; the distance profile is evaluated by a calculating or computing unit connected thereafter or downstream thereof, with the aid of the vehicle data (for example the, vehicle's own speed), and is communicated to the driver of the vehicle 1, so that the driver is given help for estimating parking spaces and therewith parking into a parking space is simplified.

Inclination or tilt angle measurement. The distance profile of the vehicle 1 to the street, that is to say the position or orientation of the vehicle 1 relative to the street, is measured by the optical system 10 arranged in the frontal area of the vehicle 1, for example in the headlight, bumper or radiator grill. The tilt angle of the vehicle 1 is then determined by an averaging (regression) of the distance profile.

Recognition of the roadway condition or driving lane condition. A digital reflection profile is established from all receiver channels (within all detected distance ranges, for example up to 10 m in front of the vehicle 1) by the optical system 10 arranged in the frontal area of the vehicle 1, for example in the headlight, bumper or radiator grill. Through the use of comparative patterns, the conditions of the roadway can be divided into certain classes (for example iced driving lane, potholes, etc.) and this can be communicated to the driver of the vehicle 1.

1. Optical system, with a measuring unit (3) which emits an optical signal as transmitted signal (13) and detects the optical signal as reflected signal (14), and with a control unit (7) which, on the basis of a transit time measurement of the optical signal (13, 14), determines the distance (dz) between a reference object (1) and target objects (2) located in the surveillance area and/or the speed of the target objects (2) located in the surveillance area, characterized
in that the surveillance area is divided into several target sectors (21) that respectively encompass a certain angular range in horizontal direction (α) and vertical direction (β),
in that the measuring unit (3) comprises a receiver unit (4) with a number of parallel connected receiver elements (8) corresponding to the number of the target sectors, whereby each receiver element (8) detects the reflected signal (14) as received signal from one of the target sectors (21), and
in that the control unit (7) comprises a number of evaluating stages (15) corresponding to the number of the receiver elements (8), whereby each evaluating stage (15) evaluates the received signal of a receiver element (8) stemming from one target sector (21).

2. Optical system according to claim 1, characterized in that, in the measuring unit (3), the received signals of the receiver elements (8) are respectively amplified and digitally converted by an allocated amplifier unit (9), and in that respectively one digital received signal of one evaluating stage (15) is provided to the control unit (7).

3. Optical system according to claim 1 or 2, characterized in that the transit time measurement is carried out in several successive measuring phases of a measuring process, in which measuring phases the receiver elements (8) respectively detect the reflected signals from a certain distance range (Δd) of the allocated target sector (21), and in that the digital received signals of the measuring phases are stored in memory stages (16) of the evaluating stages (15) of the control unit (7).

4. Optical system according to one of the claims 1 to 7, characterized in that the digital received signals of successive measuring processes are stored in the memory stages (16) of the evaluating stages (15) of the control unit (7).

5. Optical system according to one of the claims 3 or 4, characterized in that the memory stages (16) of the evaluating stages (15) of the control unit (7) are embodied as an N×N shift register array.

6. Optical system according to one of the claims 3 to 5, characterized in that the distance (dz) of the target objects (2) is determined in connection with the distance ranges (Δd).

7. Optical system according to one of the claims 3 to 6, characterized in that the evaluating unit (15) determines the speed of the target objects (2) in connection with the digital received signals of successive measuring processes stored in the memory unit (16).

8. Optical system according to claim one of the claims 3 to 7, characterized in that the received signals stored in the memory units (16) are evaluated with respect to the presence of target objects (2) in the allocated target sector (21) by threshold value stages (16) of the evaluating stages (15) of the control unit (7).

9. Optical system according to claim 8, characterized in that the presence of a target object (2) in the allocated target sector (21) is assumed upon the exceeding of a digital threshold value prescribed by the threshold value stages (16) dependent on the number of the stored measuring processes.

10. Optical system according to one of the claims 1 to 9, characterized in that a common test unit (17) is connected downstream of the evaluating stages (15) and carries out a plausibility test by means of the output signals of the evaluating stages (15).

11. Optical system according to one of the claims 1 to 10, characterized in that the measuring unit (3) comprises a transmitter unit (4) with at least one transmitter element (6).

12. Optical system according to claim 11, characterized in that the measuring unit (3) emits a pulse-form signal in the infrared spectral range as transmitted signal (13).

13. Optical system according to one of the claims 1 to 12 for early impact or crash warning before the frontal impact and/or side impact and/or rear impact of target objects (2).

14. Optical system according to one of the claims 1 to 13 for recognition of target objects (2) located in the blind spot angle.
